(19) United States
(12) Patent Application Publication
(10) Pub. No.: US 2019/0146741 A1
(43) Pub. Date: May 16, 2019

(54) DISPLAY MODULE AND DISPLAY DEVICE WITH NEAR FIELD COMMUNICATION MODULE

(71) Applicant: FLYTECH TECHNOLOGY CO., LTD, Taipei City (TW)

(72) Inventor: Tien-Hsieh Feng, Taipei City (TW)

(21) Appl. No.: 15/887,266

(22) Filed: Feb. 2, 2018

(30) Foreign Application Priority Data
Nov. 10, 2017 (TW) 106216782

(51) Int. Cl. G06F 3/147; H04B 5/00; H01Q 1/22; G06Q 20/32

(52) U.S. Cl. CPC G06F 3/147; H04B 5/0031; G06Q 20/3278; H01Q 1/22; H01Q 1/2216

(57) ABSTRACT

A display module and a display device with a near field communication module are provided. The display device includes a display module, a main circuit board and a covering member. The display module and the main circuit board are disposed within the covering member. The display module includes a display panel and the near field communication module. The display module is electrically connected with the main circuit board. The near field communication module includes a near field communication antenna and a near field communication sensing circuit. When a sensitive object is near one of the display module and the covering member, the near field communication antenna senses the sensitive object and generates a sensing wave. Consequently, the near field communication sensing circuit issues an electric signal to the main circuit board.

### FIELD OF THE INVENTION

The present invention relates to a display module, and more particularly to a display module and a display device with a near field communication module.

### BACKGROUND OF THE INVENTION

The flourishing development of modern business activities has changed the payment methods of modern people. In addition to the traditional cash payment, the utilization rate of credit card payment is gradually increasing. For example, financial cards and credit cards are widely used.

Among the credit card payment methods, the mobile payment is the most prevalent. The mobile payment uses a near field communication (NFC) technology to provide a contactless payment method. Moreover, the mobile payment integrates with a number of different credit card distribution systems such as VISA cards, Master cards, American Express cards, and so on. In other words, the mobile payment is a payment method common to all over the world.

However, the existing cash registers still have some problems while the mobile payment is performed. For example, the existing cash register at least comprises a display device and a payment device, and the display device and the payment device are located at different positions. When the consumer completes the consumption and intends to pay, the consumer has to raise the head to view the payment information on the display device of the cash register and then lower the head to find the placement of the payment device. Subsequently, the consumer completes the payment according to the presentation image of the display device. In other words, the conventional payment method is not user-friendly.

For solving the drawbacks of the conventional technologies, there is a need of providing a novel and convenient display device that integrates the near field communication (NFC) technology.

### SUMMARY OF THE INVENTION

For solving the drawbacks of the conventional technologies, the present invention provides a display module with a near field communication module and a display device. The near field communication module generates a sensing wave when a sensitive object is located near the near field communication module.

In accordance with an aspect of the present invention, there is provided a display module for a display device. The display module is electrically connected with a main circuit board of the display device. The display module includes a display panel and a near field communication module. The display panel includes a front part and a rear part. The near field communication module is electrically connected with the main circuit board. The near field communication module is installed in the rear part, or arranged between the rear part and the main circuit board. When the near field communication module senses a sensitive object near the front part, the near field communication module generates a sensing wave.

In an embodiment, the near field communication module includes a near field communication antenna and a near field communication sensing circuit. The near field communication antenna is electrically connected with the near field communication sensing circuit. The near field communication sensing circuit is electrically connected with the main circuit board.

In an embodiment, the rear part is a metallic frame with a hollow region, and the near field communication module is accommodated within the hollow region. Alternatively, the near field communication antenna is accommodated within the hollow region, and the near field communication sensing circuit is arranged between the rear part and the main circuit board or installed on the main circuit board.

In an embodiment, the display device further includes a covering member. The near field communication antenna is arranged between the covering member and the front part. The near field communication sensing circuit is arranged between the rear part and the main circuit board.

In an embodiment, when the display panel receives a control signal from the main circuit board, a sensitive region mark is shown on the front part at a position corresponding to the near field communication antenna.

In accordance with another aspect of the present invention, there is provided a display device. The display device includes a display module, a near field communication module and a main circuit board. The display module includes a front part and a rear part. The main circuit board is installed on the rear part, and electrically connected with the display module and the near field communication module. When the near field communication module senses a sensitive object near the front part, the near field communication module generates a sensing wave.

In an embodiment, the near field communication module includes a near field communication antenna and a near field communication sensing circuit. The near field communication antenna is electrically connected with the near field communication sensing circuit. The near field communication sensing circuit is electrically connected with the main circuit board.

In an embodiment, the rear part is a metallic frame with a hollow region, and the near field communication module is accommodated within the hollow region. Alternatively, the near field communication antenna is accommodated within the hollow region, and the near field communication sensing circuit is arranged between the rear part and the main circuit board or installed on the main circuit board.

In an embodiment, when the display module receives a control signal from the main circuit board, a sensitive region mark is shown on the front part at a position corresponding to the near field communication antenna.

In an embodiment, the display device further includes a covering member. The near field communication antenna is installed on the covering member or arranged between the covering member and the front part. The near field communication sensing circuit is arranged between the rear part and the main circuit board or installed on main circuit board.

In an embodiment, the covering member further includes a sensitive region mark. The sensitive region mark is installed on the covering member and aligned with the near field communication antenna.

In accordance with a further aspect of the present invention, there is provided a display device. The display device includes a display module and a covering member. The display module includes a display panel and a near field communication module. The near field communication module includes a near field communication antenna and a near field communication sensing circuit. The near field communication module is electrically connected with the display module. The covering member includes a first case and a second case. The display module and the main circuit board are arranged between the first case and the second case. When the near field communication module senses a sensitive object near one of the display panel and the first case, the near field communication module generates a sensing wave.

In an embodiment, the near field communication antenna is electrically connected with the near field communication sensing circuit. The near field communication sensing circuit is electrically connected with the main circuit board.

In an embodiment, the display panel includes a front part and a rear part. The rear part is a metallic frame with a hollow region.

In an embodiment, the near field communication module is accommodated within the hollow region. Alternatively, the near field communication antenna is accommodated within the hollow region, and the near field communication sensing circuit is arranged between the rear part and the main circuit board or installed on the main circuit board.

In an embodiment, when the display panel receives a control signal from the main circuit board, a sensitive region mark is shown on the front part at a position corresponding to the near field communication antenna.

In an embodiment, after the near field communication module senses the sensitive object near the near field communication antenna and generates the sensing wave, the near field communication sensing circuit issues an electric signal to the main circuit board.

In an embodiment, the near field communication antenna is installed on the first case or arranged between the first case and the front part of the display panel. The near field communication sensing circuit is arranged between the rear part of the display panel and the main circuit board or installed on main circuit board.

In an embodiment, the first case further includes a sensitive region mark. The sensitive region mark is installed on the first case and aligned with the near field communication antenna.

In an embodiment, after the near field communication module senses the sensitive object near the near field communication antenna and generates the sensing wave, the near field communication sensing circuit issues an electric signal to the main circuit board.

From the above description, the near field communication module is installed in the display module or the display device. When the display module or the display device senses a nearby sensitive object, a sensing wave is generated and the overall payment operation is completed. Since it is not necessary to additionally install the payment device or the sensing device, the display device of the present invention is cost-effective, user-friendly and easy-to-use.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a display device according to an embodiment of the present invention;

FIG. 2A is a schematic exploded view illustrating the display device of FIG. 1;

FIG. 2B is a schematic exploded view illustrating a display device according to another embodiment of the present invention;

FIG. 2C is a schematic exploded view illustrating a display device according to a further embodiment of the present invention;

FIG. 3 is a schematic exploded view illustrating the display device of FIG. 2A and taken along another viewpoint;

FIG. 4 schematically illustrates a sensitive region mark shown on the display device of FIG. 1; and

FIG. 5 is a schematic functional block diagram illustrating the signal exchange between a display module and a main board of the display device of FIG. 1.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown.

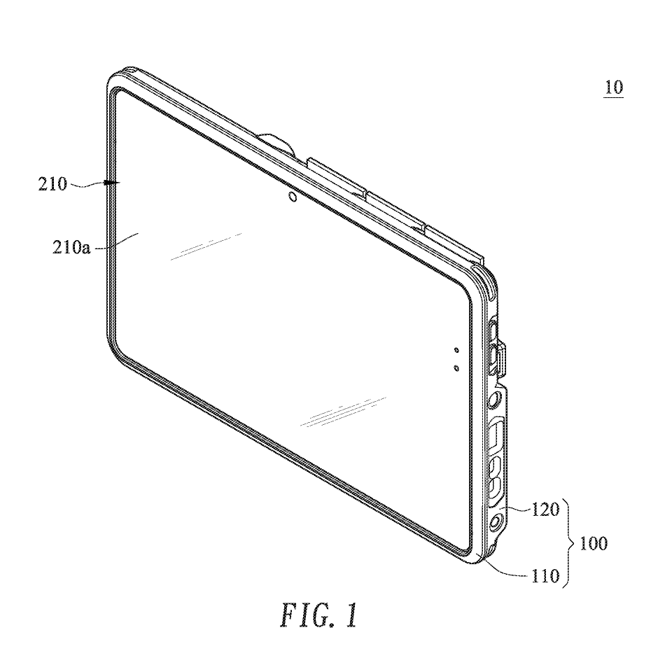

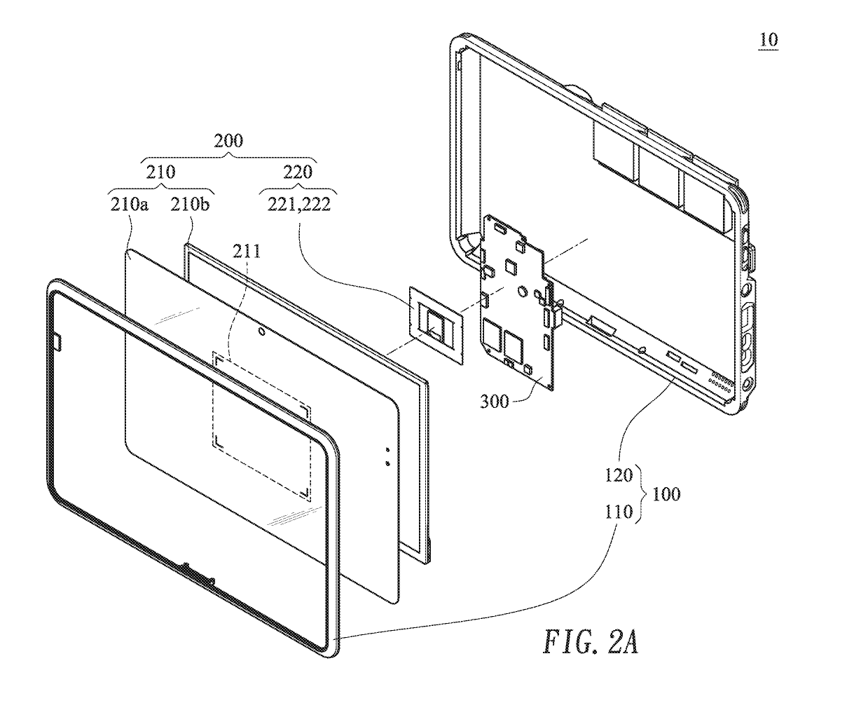

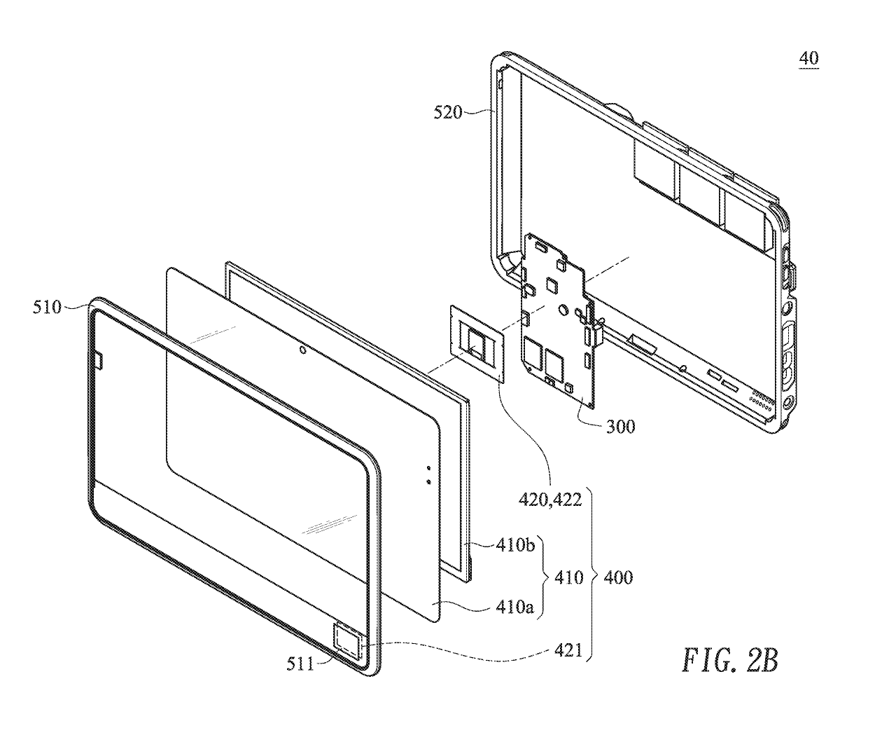

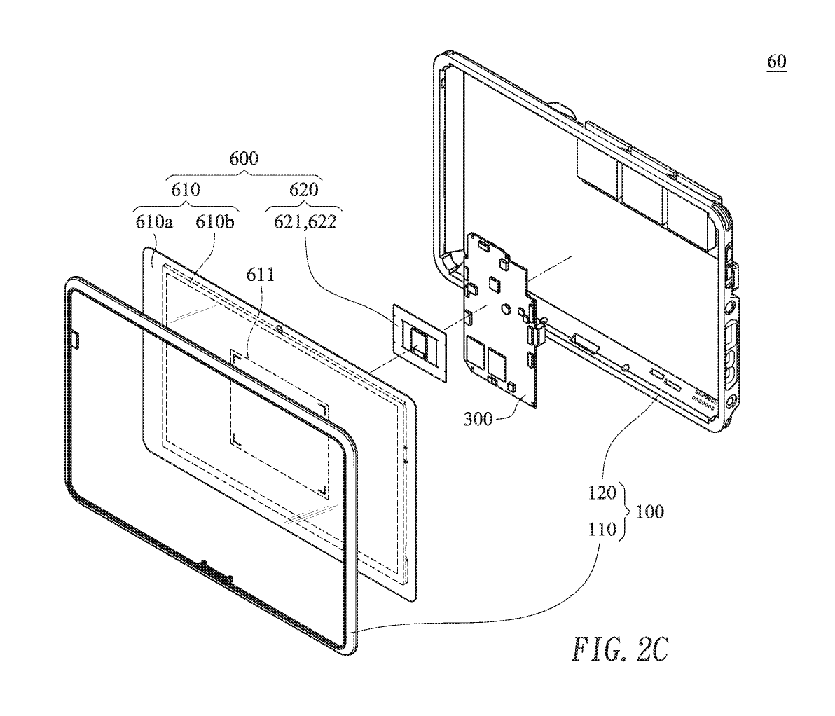

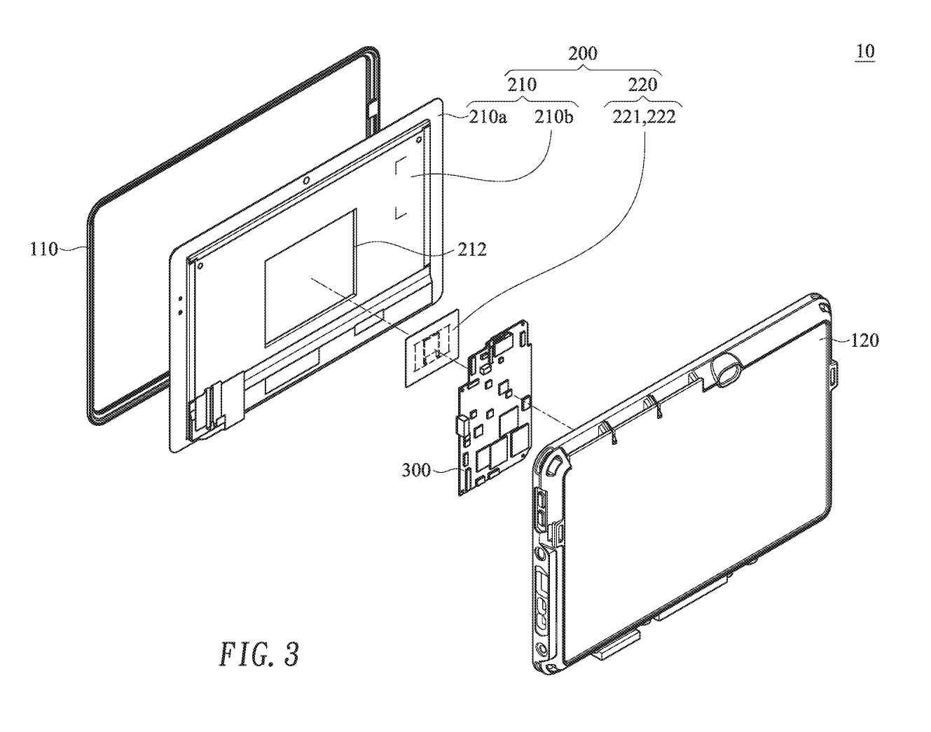

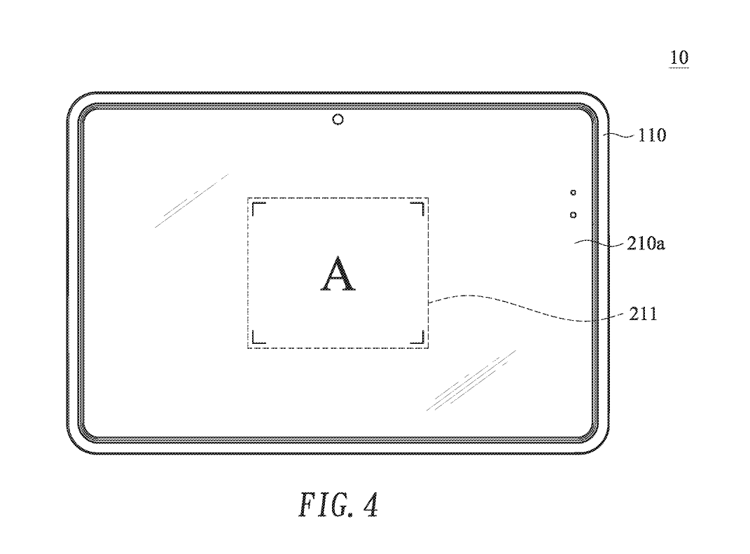

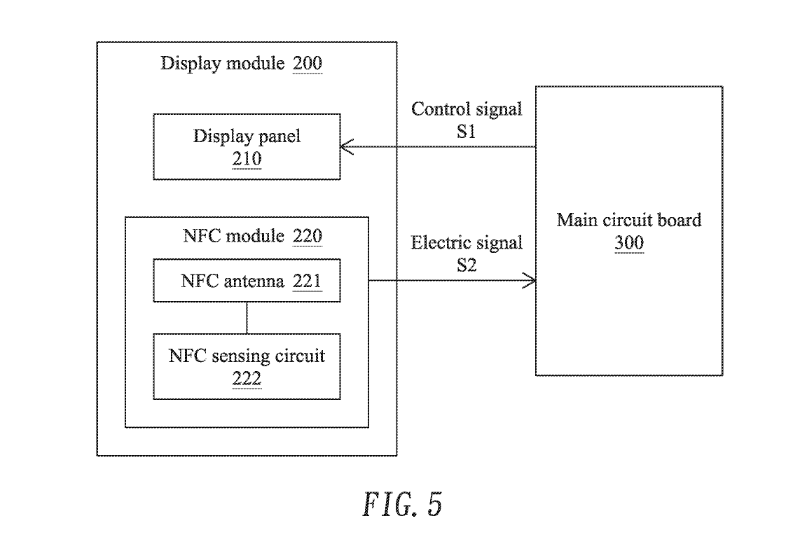

FIG. 1 is a schematic perspective view illustrating a display device according to an embodiment of the present invention. FIG. 2A is a schematic exploded view illustrating the display device of FIG. 1. FIG. 2B is a schematic exploded view illustrating a display device according to another embodiment of the present invention. FIG. 2C is a schematic exploded view illustrating a display device according to a further embodiment of the present invention. FIG. 3 is a schematic exploded view illustrating the display device of FIG. 2A and taken along another viewpoint. FIG. 4 schematically illustrates a sensitive region mark shown on the display device of FIG. 1. FIG. 5 is a schematic functional block diagram illustrating the signal exchange between a display module and a main board of the display device of FIG. 1.

Please refer to FIGS. 1, 2A and 3. In this embodiment, the display device 10 comprises a covering member 100, a display module 200 and a main circuit board 300. The covering member 100 comprises a first case 110 and a second case 120. The display module 200 comprises a display panel 210 and a near field communication module 220. The display panel 210 comprises a front part 210a and a rear part 210b. As shown in FIG. 4, a sensitive region mark 211 is shown on the front part 210a. The rear part 210b comprises a hollow region 212 for accommodating the near field communication module 220. As shown in FIG. 3, the near field communication module 220 comprises a near field communication antenna 221 and a near field communication sensing circuit 222.

The relationships between the above components will be described as follows. Please refer to FIGS. 2A, 3 and 5. The display module 200 and the main circuit board 300 are arranged between the first case 110 and the second case 120. The display panel 210 and the near field communication module 220 are electrically connected with the main circuit board 300. The near field communication antenna 221 is electrically connected with the near field communication sensing circuit 222. As shown in FIG. 5, the display panel 210 receives a control signal S1, and the near field communication module 220 issues an electric signal S2. According to the presentation image shown on the front part 210a of the display panel 210, the consumer can complete the payment operation.

In this embodiment, the near field communication module 220 is arranged between the rear part 210b of the display panel 210 and the main circuit board 300. When the near field communication module 220 senses a sensitive object near the front part 210a of the display panel 210, the near field communication module 220 generates a sensing wave.

In an embodiment, the rear part 210b of the display panel 210 is a metallic frame. For facilitating the near field communication module 220 to sense the sensitive object, the near field communication module 220 has to be disposed within the hollow region 212. It is noted that the applications of the near field communication module 220 are not restricted.

In FIG. 2B, a display device 40 according to another embodiment of the present invention is shown. The display device 40 comprises a main circuit board 300, a display module 400, a first case 510 and a second case 520. In this embodiment, the first case 510 comprises a sensitive region mark 511. The display module 400 comprises a display panel 410 and a near field communication module 420. The display panel 410 comprises a front part 410a and a rear part 410b. The near field communication module 420 comprises a near field communication antenna 421 and a near field communication sensing circuit 422. In comparison with the above embodiment, the first case 510 comprises the sensitive region mark 511. Consequently, the near field communication antenna 421 is directly installed on first case 510 and near the sensitive region mark 511, or the near field communication antenna 421 is arranged between the first case 510 and the front part 410a of the display panel 410. The near field communication sensing circuit 422 is installed on the rear part 410b of the display panel 410, or the near field communication sensing circuit 422 is arranged between the rear part 410b of the display panel 410 and the main circuit board 300, or the near field communication sensing circuit 422 is installed on the main circuit board 300.

In FIG. 2C, a display device 60 according to a further embodiment of the present invention is shown. The display module 600 comprises a display panel 610 and a near field communication module 620. The display panel 610 comprises a front part 610a and a rear part 610b. In comparison with the above embodiments, the rear part 610b of the display panel 610 is not a metallic frame. Consequently, the rear part 610b is not equipped with the hollow region 212 as shown in FIG. 3. That is, the near field communication module 620 is directly installed on the rear part 610b, or the near field communication module 620 is arranged between the rear part 610b and the main circuit board 300.

As mentioned above, the installation position of the near field communication antenna of the near field communication module may be adjusted according to the structure of the covering member or the structure of the display panel. For example, the near field communication antenna is installed on first case, or arranged between the first case and the front part of the display panel, or arranged between the rear part of the display panel and the main circuit board. Consequently, the near field communication antenna can sense the sensitive object near the sensitive region mark. In accordance with a feature of the present invention, the near field communication module is installed in the display device. Consequently, the display device is capable of sensing the sensitive object near the sensitive region mark and completing the overall payment operation. Since it is not necessary to additionally install the payment device or the sensing device, the display device of the present invention is cost-effective, user-friendly and easy-to-use.

Hereinafter, the relationship between the display module and the main circuit board will be illustrated in more details with reference to FIG. 2A. Please refer to FIGS. 2A, 3 and 5 again. When the consumer completes the consumption and intends to pay, the main circuit board 300 issues the control signal S1 to the display panel 210. According to the control signal S1, the sensitive region mark 211 is shown on the front part 210a of the display panel 210 at the position corresponding to the near field communication antenna 221. For example, as shown in FIG. 4, the sensitive region mark 211 corresponds to the position of the letter A. In practice, a payment area or a pattern or symbol corresponding to the payment operation is displayed on the sensitive region mark 211 to guide the user to place the sensitive object to the nearby position of the sensitive region mark 211 and complete the payment operation. The sensitive object is a financial card, a credit card, a stored value card and any other appropriate electronic device with a mobile payment function.

According to the message shown on the front part 210a of the display panel 210, the consumer may place the payment object (e.g., a credit card, a smart phone, a smart bracelet or a travel card) to the position near the sensitive region mark 211 of the front part 210a. Consequently, the near field communication module 220 senses the sensitive object through the near field communication antenna 221 and generates the corresponding sensing wave. Meanwhile, the near field communication sensing circuit 222 issues the electric signal S2 to the main circuit board 300. Consequently, the overall payment operation is completed.

It is noted that numerous modifications and alterations may be made while retaining the teachings of the invention. That is, the structures and specifications of the above components may be varied according to the practical requirements. For example, the display panel is a touch screen, the position of the near field communication module is determined according to the design of the overall display device, and the sensitive region mark is located at one of the first case and the front part of the front panel. As long as the functions of the present invention are achieved, the structures of the display device are not restricted.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A display module for a display device, the display module being electrically connected with a main circuit board of the display device, the display module comprising:
a display panel comprising a front part and a rear part; and
a near field communication module electrically connected with the main circuit board,
wherein the near field communication module is installed in the rear part, or arranged between the rear part and the main circuit board, wherein when the near field communication module senses a sensitive object near the front part, the near field communication module generates a sensing wave.

2. The display module according to claim 1, wherein the near field communication module comprises a near field communication antenna and a near field communication sensing circuit, wherein the near field communication antenna is electrically connected with the near field communication sensing circuit, and the near field communication sensing circuit is electrically connected with the main circuit board.

3. The display module according to claim 2, wherein the rear part is a metallic frame with a hollow region, and the near field communication module is accommodated within the hollow region, or wherein the near field communication antenna is accommodated within the hollow region, and the near field communication sensing circuit is arranged between the rear part and the main circuit board or installed on the main circuit board.

4. The display module according to claim 2, wherein the display device further comprises a covering member, wherein the near field communication antenna is arranged between the covering member and the front part, and the near field communication sensing circuit is arranged between the rear part and the main circuit board.

5. The display module according to claim 2, wherein when the display panel receives a control signal from the main circuit board, a sensitive region mark is shown on the front part at a position corresponding to the near field communication antenna.

6. A display device, comprising:
a display module comprising a front part and a rear part;
a near field communication module; and
a main circuit board installed on the rear part, and electrically connected with the display module and the near field communication module,
wherein when the near field communication module senses a sensitive object near the front part, the near field communication module generates a sensing wave.

7. The display device according to claim 6, wherein the near field communication module comprises a near field communication antenna and a near field communication sensing circuit, wherein the near field communication antenna is electrically connected with the near field communication sensing circuit, and the near field communication sensing circuit is electrically connected with the main circuit board.

8. The display device according to claim 7, wherein the rear part is a metallic frame with a hollow region, and the near field communication module is accommodated within the hollow region, or wherein the near field communication antenna is accommodated within the hollow region, and the near field communication sensing circuit is arranged between the rear part and the main circuit board or installed on the main circuit board.

9. The display device according to claim 8, wherein when the display module receives a control signal from the main circuit board, a sensitive region mark is shown on the front part at a position corresponding to the near field communication antenna.

10. The display device according to claim 7, wherein the display device further comprises a covering member, wherein the near field communication antenna is installed on the covering member or arranged between the covering member and the front part, and the near field communication sensing circuit is arranged between the rear part and the main circuit board or installed on main circuit board.

11. The display device according to claim 10, wherein the covering member further comprises a sensitive region mark, and the sensitive region mark is installed on the covering member and aligned with the near field communication antenna.

12. A display device, comprising:
a display module comprising a display panel and a near field communication module, wherein the near field communication module comprises a near field communication antenna and a near field communication sensing circuit, and the near field communication module is electrically connected with the display module; and
a covering member comprising a first case and a second case, wherein the display module and the main circuit board are arranged between the first case and the second case,
wherein when the near field communication module senses a sensitive object near one of the display panel and the first case, the near field communication module generates a sensing wave.

13. The display device according to claim 12, wherein the near field communication antenna is electrically connected with the near field communication sensing circuit, and the near field communication sensing circuit is electrically connected with the main circuit board.

14. The display device according to claim 13, wherein the display panel comprises a front part and a rear part, wherein the rear part is a metallic frame with a hollow region.

15. The display device according to claim 14, wherein the near field communication module is accommodated within the hollow region, or wherein the near field communication antenna is accommodated within the hollow region, and the near field communication sensing circuit is arranged between the rear part and the main circuit board or installed on the main circuit board.

16. The display device according to claim 15, wherein when the display panel receives a control signal from the main circuit board, a sensitive region mark is shown on the front part at a position corresponding to the near field communication antenna.

17. The display device according to claim 16, wherein after the near field communication module senses the sensitive object near the near field communication antenna and generates the sensing wave, the near field communication sensing circuit issues an electric signal to the main circuit board.

18. The display device according to claim 14, wherein the near field communication antenna is installed on the first case or arranged between the first case and the front part of the display panel, and the near field communication sensing circuit is arranged between the rear part of the display panel and the main circuit board or installed on main circuit board.

19. The display device according to claim 18, wherein the first case further comprises a sensitive region mark, and the sensitive region mark is installed on the first case and aligned with the near field communication antenna.

20. The display device according to claim 19, wherein after the near field communication module senses the sensitive object near the near field communication antenna and generates the sensing wave, the near field communication sensing circuit issues an electric signal to the main circuit board.
